(19) United States
(12) Patent Application Publication
(10) Pub. No.: US 2025/0266742 A1
(43) Pub. Date: Aug. 21, 2025

(54) METHOD OF WINDING ROTATING ELECTRICAL MACHINE COMPONENTS

(71) Applicant: BorgWarner Inc., Auburn Hills, MI (US)

(72) Inventors: Wei Wang, Fort Wayne, IN (US); Kirk Neet, Noblesville, IN (US)

(21) Appl. No.: 19/203,596

(22) Filed: May 9, 2025

Related U.S. Application Data
(60) Provisional application No. 63/645,234, filed on May 10, 2024.

(51) Int. Cl. H02K 15/095

(52) U.S. Cl. CPC H02K 15/095

(57) ABSTRACT

A method of winding wire around a portion of a rotating electrical machine includes: initially winding a first portion of wire around a tooth leaving sufficient space for a winding machine to access the tooth; winding a second portion of wire around a mandrel; and moving the second portion of wire off of the mandrel towards the tooth and over the first portion of wire.

### REFERENCE TO RELATED APPLICATIONS

This application claims the benefit of U.S. Provisional Application Ser. No. 63/645,234 filed on May 10, 2024. The content of this priority application is incorporated herein by reference in its entirety.

### TECHNICAL FIELD

The present application relates to rotating electrical machines and, more particularly, to stator windings of rotating electrical machines.

### BACKGROUND

Rotating electrical machines typically include a stator assembly having stator windings filling a plurality of stator slots and a rotor assembly that is received concentrically within the stator assembly. The rotor assembly can include a rotor, a rotor shaft, and rotor windings wound around rotor teeth of the rotor. The insertion of stator windings in the stator slots and the addition of rotor windings around the rotor teeth can be carried out in a variety of ways each of which may have its own advantages or disadvantages. However, it would be helpful to optimize the winding techniques to decrease cost and increase slot fill or wire density.

### SUMMARY

In one implementation, a method of winding wire around a portion of a rotating electrical machine includes: initially winding a first portion of wire around a tooth leaving sufficient space for a winding machine to access the tooth; winding a second portion of wire around a mandrel; and moving the second portion of wire off of the mandrel towards the tooth and over the first portion of wire.

In another implementation, a method of winding wire around a portion of a rotating electrical machine includes initially winding a first portion of wire around a rotor tooth leaving sufficient space for a winding machine to access the rotor tooth; winding a second portion of wire around a mandrel positioned adjacent the rotor tooth without cutting the first portion of the wire or the second portion of the wire; and moving the second portion of wire off of the mandrel towards the tooth and over the first portion of wire.

### BRIEF DESCRIPTION OF THE DRAWINGS

FIG. 1 is a cross-sectional view depicting an implementation of an aspect of a method of winding wire around a portion of a rotating electrical machine;

FIG. 2 is a cross-sectional view depicting an implementation of another aspect of a method of winding wire around a portion of a rotating electrical machine;

FIG. 3 is a cross-sectional view depicting an implementation of another aspect of a method of winding wire around a portion of a rotating electrical machine;

FIG. 4 is a cross-sectional view depicting an implementation of another aspect of a method of winding wire around a portion of a rotating electrical machine;

FIG. 5 is a cross-sectional view depicting an implementation of another aspect of a method of winding wire around a portion of a rotating electrical machine;

FIG. 6 is a cross-sectional view depicting an implementation of another aspect of a method of winding wire around a portion of a rotating electrical machine; and

FIG. 7 is a cross-sectional view depicting an implementation of another aspect of a method of winding wire around a portion of a rotating electrical machine.

### DETAILED DESCRIPTION

A method of adding windings to a component of a rotating electrical machine can involve initially winding one rotor tooth or a plurality of rotor teeth using a winding machine. The process of winding each rotor tooth may involve leaving a space in between the rotor teeth sufficiently large to permit a needle or other portion of the winding machine to wrap rotor wire around the rotor tooth. The existence of space in between rotor teeth may be inefficient given a desire to have a large slot fill percentage occupied by wire. The method of adding windings to a component of a rotating electrical machine can begin by initially winding rotor wire around at least one rotor tooth. Without cutting the rotor wire, the winding machine can continue winding wire around a mandrel positioned adjacent the rotor tooth. Once a desired amount of wire has been added to the mandrel, the wire wound around the mandrel can be moved off of the mandrel towards the rotor tooth such that the winding encircles the previously-wound wire on the rotor tooth. The wound wire moved off the mandrel over the previously-wound wire can then be drawn taut. The rotor can then be indexed to move to another rotor tooth and the process can be repeated until all of the rotor teeth have rotor windings. The process of initially winding wire around the rotor tooth and then filling the space used to create the initial winding can increase slot fill helping to create a more efficient rotating electrical machine. The embodiments of methods disclosed here are described with regard to rotor teeth. However, it should be appreciated that the method could also be applied to a stator using stator wire.

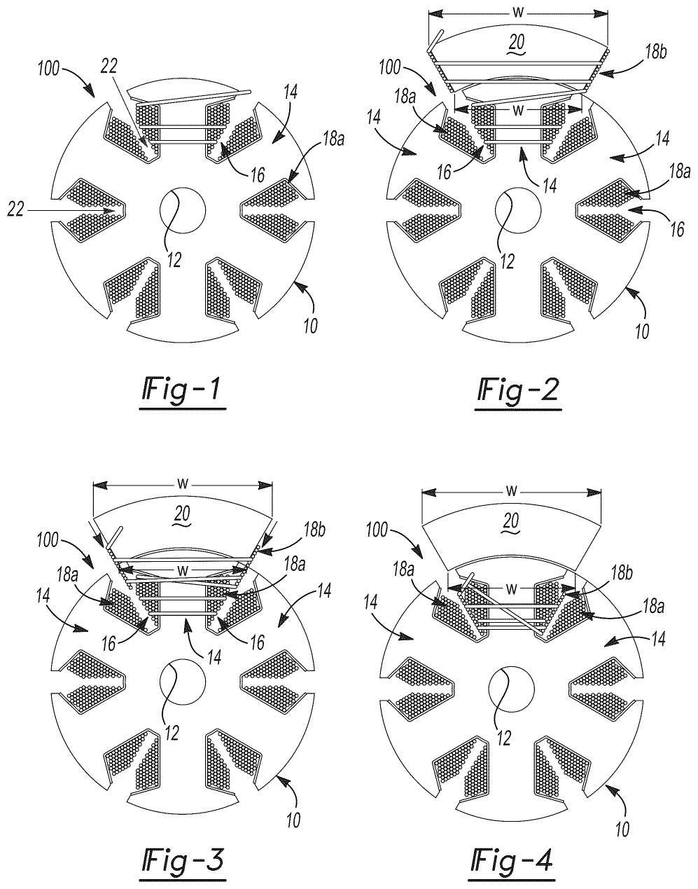

Turning to FIG. 1, the method 100 begins at step one. At step one, a rotor assembly 10 configured to be received by a stator assembly of a rotating electrical machine is shown. The rotor assembly 10 includes an inner diameter 12 configured to receive an output shaft and a plurality of rotor teeth 14 spaced around the circumference of the rotor assembly 10 and extending radially outwardly away from the inner diameter 12. Examples of rotating electrical machines include brushless DC synchronous motors and wound rotor synchronous motors. Each rotor tooth 14 is configured to receive a rotor winding 16 around the circumference of the rotor tooth 14 from a winding machine (not shown). The rotor tooth 14 can be wound in any one of a variety of ways. For example, the rotor assembly 10 can be mounted on a needle winding machine, which can position a needle in close proximity to the rotor tooth 14 and encircle the rotor tooth 14 with rotor wire 18. The needle winding machine can move the needle around the rotor tooth 14 to apply a first portion of rotor wire 18a around the circumference of the rotor tooth 14. It is also possible to carry out the methods described here by winding rotor wire around two or more rotor teeth as part of step one. In other implementations, different needle winding machines can each be used to individually wind rotor wire around each rotor tooth. It should also be appreciated that other winding machines can be used with the methods disclosed here, such as flyer winding or linear winding.

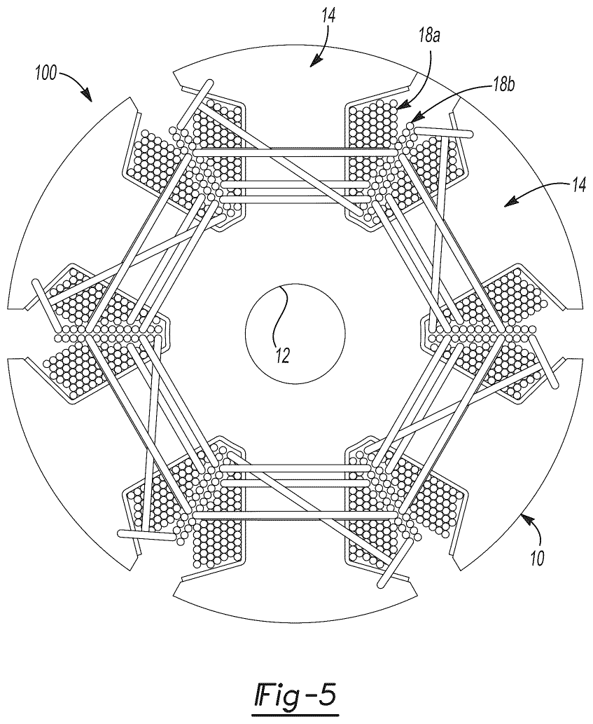

The wire winding method 100 proceeds as is shown in FIGS. 2-5. The method 100 continues to step two, as is shown in FIG. 2. The needle of the needle winding machine can be positioned adjacent a mandrel 20. The mandrel 20 can have a circumference that is slightly larger than the circumference of rotor tooth 14 to receive the rotor winding 16. The mandrel 20 can be shaped so an end of the mandrel 20 nearest the rotor tooth 14 can have a width (w) that is smaller than a width (W) at an opposite end of the mandrel 20 away from the rotor tooth 14. The wire winding machine can encircle the mandrel 20 with a second portion of the rotor wire 18b for creating a rotor tooth winding as is shown in FIG. 2.

Once a desired amount of the second portion of rotor wire 18b has been wrapped around the mandrel 20, the method 100 proceeds to step three and the rotor wire 18b can be pushed off of the mandrel 20 into the slot 22 between adjacent rotor teeth 14 and onto the rotor tooth 14. The second portion of rotor wire 18b initially wrapped around the mandrel 20 can fill the empty space in between adjacent rotor teeth 14 initially provided to permit the needle winding machine to wind wire around the rotor tooth 14. The needle winding machine can then angularly displace the rotor assembly 10 and repeat steps one through five on an adjacent rotor teeth 14. This process can continue until each rotor tooth 14 is wound with rotor wire.

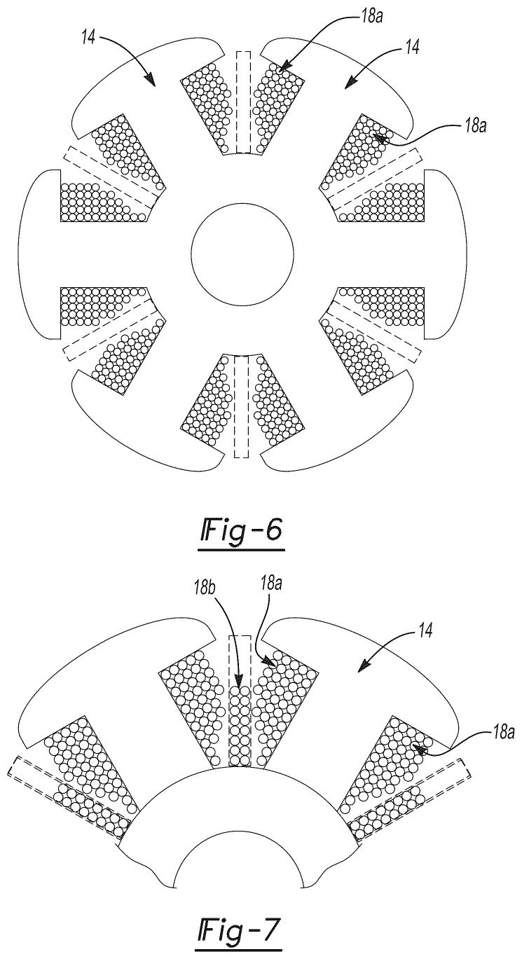

Past rotor assemblies having rotor teeth wound by needle winding machines can create rotor assemblies having 40-45% wire fill in between adjacent rotor teeth. However, this can leave open unfilled space in between adjacent rotor teeth as shown by the hashed lines in FIG. 6. In contrast, the proposed method can fill that open space as shown in FIG. 7 and can fill 60% or more of the space between adjacent rotor teeth. The proposed method can increase the percentage of fill between the adjacent rotor teeth by, in one implementation, twenty percent thereby reducing winding loss by 20%. The proposed method was used to create a rotor assembly included in a 245 kW wound rotor synchronous machine. A rotor assembly using the disclosed method resulted in 20% reduction of copper loss on rotor winding and a 10% continuous torque increase.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A method of winding wire around a portion of a rotating electrical machine, comprising:
(a) initially winding a first portion of wire around a tooth leaving sufficient space for a winding machine to access the tooth;
(b) winding a second portion of wire around a mandrel; and
(c) moving the second portion of wire off of the mandrel towards the tooth and over the first portion of wire.

2. The method recited in claim 1, wherein the winding machine comprises a needle winding machine.

3. The method recited in claim 1, wherein the first portion of wire is wound around a single tooth.

4. The method recited in claim 1, wherein the first portion of wire is wound around a plurality of teeth.

5. The method recited in claim 1, wherein the first portion of wire and the second portion of wire fill sixty percent or more of a space between adjacent teeth.

6. The method recited in claim 1, wherein the tooth is attached to a rotor assembly of the rotating electrical machine.

7. A method of winding wire around a portion of a rotating electrical machine, comprising:
(a) initially winding a first portion of wire around a rotor tooth leaving sufficient space for a winding machine to access the rotor tooth;
(b) winding a second portion of wire around a mandrel positioned adjacent the rotor tooth without cutting the first portion of the wire or the second portion of the wire; and
(c) moving the second portion of wire off of the mandrel towards the tooth and over the first portion of wire.

8. The method recited in claim 7, wherein the winding machine comprises a needle winding machine.

9. The method recited in claim 7, wherein the first portion of wire is wound around a single rotor tooth.

10. The method recited in claim 7, wherein the first portion of wire is wound around a plurality of rotor teeth.

11. The method recited in claim 7, wherein the first portion of wire and the second portion of wire fill sixty percent or more of a space between adjacent rotor teeth.
